(19) United States
(12) Patent Application Publication
(10) Pub. No.: US 2026/0307314 A1
(43) Pub. Date: Oct. 8, 2026

(54) METHOD FOR PRODUCING PLASTICS STRAPPING BANDS

(71) Applicant: Teufelberger Gesellschaft m.b.H., Wels (AT)

(72) Inventor: Thomas GAHLEITNER, Krenglbach (AT)

(73) Assignee: Teufelberger Gesellschaft m.b.H., Wels (AT)

(21) Appl. No.: 19/480,090

(22) PCT Filed: May 2, 2024
(86) PCT No.: PCT/AT2024/060183

§ 371 Date: Oct. 30, 2025

(30) Foreign Application Priority Data
May 3, 2023 (AT) A50332/2023

(51) Int. Cl. B29C 48/00; B29C 48/07; B29C 48/92; B29K 101/12; B29L 7/00

(52) U.S. Cl. CPC B29C 48/0022; B29C 48/0018; B29C 48/07; B29C 48/92; B29C 2793/0036; B29C 2793/009; B29C 2948/92133; B29C 2948/92447; B29C 2948/92628; B29C 2948/92942; B29K 2101/12; B29L 2007/007

(57) ABSTRACT

A method for producing plastic strappings includes the method steps: providing at least one first plastic material, subsequently melting the first plastic material, subsequently forming a film strand, subsequently splitting the film strand into first strapping strands with first strapping strand widths and first strapping strand thicknesses along a material transport direction using splitting devices and subsequently drawing the first strapping strands to second strapping strands with second strapping strand widths and second strapping strand thicknesses in the material transport direction using a stretching device.

The invention relates to a method for producing plastic strappings.

Plastic strappings are used predominantly for securing goods and/or for the secured fixing of goods. To this end, these strappings are wrapped around the goods to be secured and the strappings are tensioned, and the ends of the strappings are generally interconnected, for example by welding. Strappings from plastic have numerous advantages over strappings from other materials, such as steel. For example, plastic strappings are simpler and lower-cost to produce, simpler to handle, corrosion-free and also have a lower CO₂ footprint. Such strappings and/or their application purpose and their properties are generally specified in EN 13394, for example, and/or in national standards corresponding to this European standard, such as ÖNORM EN 13394, for example.

Thermoplastic plastics and/or plastic materials are used to produce plastic strappings. The high tensile strengths required for the purpose of use are provided to the plastic strappings by mono-axial drawing by means of so-called stretching units. Such drawing ensures that an orientation of the macromolecule chains in a stretching direction and/or longitudinal direction is induced in the plastic strappings, whereby the high tensile strengths of the plastic materials in this direction are achieved. Especially in semi-crystalline, thermoplastic plastic materials, this achieves similarly high tensile strengths as in steel, for example.

The usual production methods for plastic strappings comprise melting the thermoplastic plastic materials, usually as part of an extrusion, forming and cooling down and said drawing. Here, for example a production of individual strapping strands and the drawing of the individual strapping strands may be provided, wherein absolutely also multiple strapping strands may be extruded, formed and drawn in parallel.

Alternatively, also a production method in which a very wide strand in the form of a film is extruded, formed and subsequently mono-axially drawn is used. The resulting, drawn film is then split into individual strapping strands in a longitudinal direction and processed further. Usually, the resulting strapping strands are wound up on spools as so-called endless strands for custom packaging and cut into ready-to-use strappings with a respectively suitable and/or required strapping length only at the place of use.

The method of producing films, the drawing and subsequent splitting of films into individual strands has long been known. This production method is summarized and described, for example in the beginning of DE 40 07 560 A1. Generally, such a cutting and/or splitting of mono-axially drawn films in a longitudinal and/or drawing direction can be achieved without exerting a large amount of force, as the films to be split often do not have a high tensile strength and/or tear resistance in this direction. Also, the splitting of mono-axially drawn films allows for a good control of the desired strapping widths.

However, precisely this previously known method step of cutting and/or splitting a drawn film may also be problematic. For example, due to the firm consistency of drawn films, the cutting of drawn films is inherently accompanied by high abrasion and the respective cutting tools are therefore subject to high wear. In addition, the cutting and/or splitting of drawn films may lead to damage of the split strapping strands themselves. In particular, due to the low tear resistances, a so-called splicing of the mono-axially drawn plastic strands may occur along the drawing direction during the splitting, and/or also notches may form on the strapping strand edges. This may be accompanied by an increased level of reject production. Furthermore, in this previously known execution of the method, the plastic materials used must have a high degree of purity, as foreign material beside the thermoplastic polymers may affect the cutting operation of the drawn films. In addition, also the drawing operation preceding the splitting may be problematic due to the great width of the film strand and in particular lead to inconsistent strand thicknesses along the width extension of a film strand.

It was the object of the present invention to overcome the still existing disadvantages of the prior art and make available a method by means of which plastic strappings may be produced so as to be highly process-reliable, as independent as possible of the plastic material used and without a high wear of splitting devices, and without a large number of rejects.

This object is achieved by means of a method in accordance with the claims.

The method for producing plastic strappings comprises the following method steps in the specified sequence:
provisioning a first plastic material consisting of 70 wt % to 100 wt % thermoplastic, first polymer and 0 wt % to 30 wt % of another component or multiple other components,
subsequently melting the first plastic material by means of an extrusion device while forming a first plastic melt,
subsequently forming a film strand by feeding at least the first plastic melt to a forming device in a material transport direction, and cooling down the first plastic material,
subsequently splitting and/or cutting the film strand into first strapping strands with first strapping strand widths and first strapping strand thicknesses along the material transport direction by means of splitting devices,
subsequently drawing the first strapping strands in the material transport direction to second strapping strands with second strapping strand widths and second strapping strand thicknesses by means of a stretching device.

Here, the specified sequence of the method steps and the term “subsequently” are to be understood such that a respectively “subsequent” method step is to be executed after the antecedently specified method step. However, this does not require for a “subsequent” method step to be executed immediately following the preceding method step. Rather, the execution of intermediate steps, even intermediate steps not explicitly described here, between the individual, specified method steps is possible and not excluded. The material transport direction mentioned may, as generally known, also be referred to as and/or is synonymous with the machine direction (MD).

The present method may in particular be provided for producing plastic strappings as specified in (ÖNORM) EN 13394 and/or in accordance with (ÖNORM) EN 13394. The method may therefore be provided for producing plastic strappings with a tensile strength of at least 300 N/mm².

In particular a plastic material consisting of 80 wt % to 98 wt % thermoplastic, first polymer and 2 wt % to 20 wt % of another component or multiple other components may be provisioned as the first plastic material. Independent of the amount of the other component or of the other components of the first plastic material, this or these other component(s) may be formed by fillers, additives, plasticizers or also by one or more other polymer(s) than the first polymer, for example.

The targeted cooling down of the film strand to a desired target temperature for the subsequent splitting step may be performed exclusively by means of the forming device itself. To this end, the first plastic melt may be cooled down, for example by means of at least one temperature-controllable roll and/or roll with a temperature-controllable roll surface of the forming device. For example, a cooling agent may be able to be applied to at least one roll of the forming device. In addition, also a separate cooling down of the plastic melt before the forming of the film strand and/or an additional, separate cooling down of the film strand after forming the film strand may be performed by means of an additional cool-down device, such as a water bath. A film strand thickness of the film strand may be adjusted in a targeted manner, for example by guiding the first plastic melt through a gap between adjacent rolls, as generally known, wherein at least one of the adjacent rolls may be arranged so as to be adjustable for modifying the film strand thickness. The forming device may be formed by a rolling mill, also referred to as a calender and/or smoothing calender, as generally known.

The splitting of the film strand may be carried out by means of splitting devices configured as knife blades, circular blades that are non-rotatable or rotatable along or opposite the material transport direction, or also by means of splitting devices configured as a laser or water beam, for example.

The splitting of the film strand before the drawing enables the cutting and/or slitting operation to be carried out very gently and with a very low wear and little abrasion. This is possible as the film strand still has a high temperature and is still relatively soft at this time of the method. Here, this relatively high temperature is actually necessary for the subsequent drawing step.

A thickness of the film strand after the forming and/or also the first strapping strand thicknesses after the splitting may be adjusted to 0.6 mm to 3.8 mm, preferably 0.8 mm to 2.8 mm, for example. Through the drawing, the second strapping strand thicknesses can be adjusted to a value of 0.15 mm to 1.8 mm, preferably of 0.2 mm to 1.4 mm. Through the splitting and subsequent drawing, the second strapping strand widths can be adjusted to a value of 3 mm to 40 mm, in particular 4 mm to 36 mm, wherein the second strapping strand widths may be selected predominantly according to the respectively intended purpose of use for the plastic strappings.

Surprisingly, it turned out in the context of the performance of the splitting before the drawing, on the one hand, that despite the still soft consistency of the film strand, a highly precise splitting of the film strand into the individual, first strapping strands is possible by means of conventional splitting and/or cutting devices, and that there are hardly any deviations in the respective, first strapping strand widths. Equally surprisingly, it turned out that, in this execution of the method, also second, drawn strapping strands with very uniform strapping strand widths and strapping strand thicknesses can be created after the drawing. This is possible despite the considerable deforming that inherently accompanies the drawing following the splitting of the first strapping strands. For the required tensile strengths of the plastic strappings, drawing ratios of 1:4 to 1:20 are typically required, which, as mentioned above, entails considerable deforming of the plastic materials as part of the drawing.

Furthermore, it also turned out that a splitting of a film and/or of a film strand before the drawing is more tolerant with respect to the plastic materials that can be used than the splitting after the drawing as in accordance with the prior art. In particular, an execution of the method with the splitting before the drawing is less problematic with respect to uniformity and quality of the plastic materials used, as will be explained in more detail below.

Subsequently to the method step of the drawing, other method steps may optionally be carried out. For example, as generally known, a drawn strapping strand may yet be embossed, waxed or treated otherwise. Subsequently, the strapping strands may be custom packaged, of course. Usually, the resulting strapping strands are wound up on spools as so-called endless strands for custom packaging and are cut into ready-to-use strappings with a respectively suitable and/or required strapping length only at the place of use.

In an advancement of the method, it may be provided that the film strand is cooled down to a temperature of 75° C. to 135° C. for the method step of the splitting.

Below the specified temperature range, there may already be an increased wear of the splitting devices, in particular in splitting devices in the form of cutting tools, in some plastic materials. Above the specified temperature range, for example due to an increased material flow of the plastic material, the first strapping strands may stick together again, and first strapping strands with inhomogeneous first strapping strand widths and strapping strand thicknesses may be formed, in particular in the peripheries of the strapping strands. In particular, the film strand may be cooled down to a temperature of 80° C. to 130° C. for the method step of the splitting.

Furthermore, it may be provided in the method that the forming of the film strand is carried out by means of a forming device comprising rotatably mounted rolls.

In particular, the forming device may be formed by a so-called rolling mill, also referred to as a calender and/or smoothing calender. As mentioned above, the forming of the film strand may be performed by means of such rolls, wherein a film strand thickness of the film strand may be adjusted in a targeted manner, for example by guiding the first plastic melt through a gap between adjacent rolls. Here, at least one of the adjacent rolls may be arranged so as to be adjustable for modifying the film strand thickness. In the present method, forming devices comprising rolls have proven particularly well-suited for forming film strands with a highly uniform and even structure and very evenly designed surfaces of the top and bottom sides.

In this context, it may also be expedient if at least one surface of the film strand is structured by means of at least one structured roll surface as part of the method step of the forming of the film strand.

Such a surface structure on at least one surface may be useful in particular when using the plastic strappings for forming a strapping. For example, such a surface structure can support and/or facilitate the commonly performed welding. In particular, such a surface structure can make a so-called friction welding operation considerably easier and/or more efficient. For example, the at least one surface of the film strand may be provided with a microstructure, in particular with a microstructure in the sense of a matting, which microstructure is not detectable by the naked eye. Alternatively, it may also be of advantage for specific applications, however, if the surfaces of the film strand are designed so as to be very smooth, i.e. are smoothed by means of at least one roll surface.

In a preferred embodiment of the method, it may be provided that at least some of the splitting devices are adjusted along the direction extending parallel to the strapping strand widths for adjusting the first strapping strand widths.

Such an execution of the method allows for a simple but efficient adjusting of a respectively desired first strapping strand width of the undrawn strapping strands, and, in combination with the subsequent drawing, therefore also a targeted adjusting of respectively desired second strapping strand widths of the second strapping strands and/or of the ultimately resulting plastic strappings. In particular, all existing splitting devices may be adjusted along the direction extending parallel to the strapping strand widths for adjusting the first strapping strand widths. In addition, in the context of the adjusting along the strapping strand widths, it may also be provided, however, that at least some of the splitting devices are adjusted away from the film strand and/or the first strapping strands.

It may further also be useful in the context of the adjusting of the splitting devices that actual values of the second strapping strand widths are detected by means of at least one sensor device subsequently to the drawing, and the splitting devices are adjusted along the direction extending parallel to the strapping strand widths with respect to respectively desired target values for the second strapping strand widths on the basis of these determined actual values for adjusting the first strapping strand widths.

This measure allows for a simple and variable adjusting of respectively desired strapping strand widths of the first and second strapping strands and thus provisions a particularly flexible execution of the method. The at least one sensor device may in particular be formed by an optical sensor, in particular a camera.

To automate the adjusting of the splitting devices along the direction of the strapping strand widths, it may be expedient here if the detected actual values of the second strapping strand widths are transmitted to a control device by the sensor device and the splitting devices are adjusted along the direction extending parallel to the strapping strand widths through automated control by the control device for adjusting the first strapping strand widths.

This enables in particular a high level of automation of the method.

Yet, independent of this, a method variant may also be advantageous in which, subsequently to the drawing, actual values of the second strapping strand thicknesses are detected by means of at least one sensor device and that a film strand thickness of the film strand is adjusted with respect to respectively desired target values for the second strapping strand thicknesses by means of the forming device.

This measure allows in particular a simple and variable adjusting of respectively desired strapping strand thicknesses of the first and second strapping strands. The at least one sensor device may be formed by an optical sensor again, in particular a camera. Here, basically the same sensor device may be used that is also used for determining the second strapping strand widths, or also a separate sensor device, of course.

Also in relation to the determining of the second strapping strand thicknesses, it may be provided again that the detected actual values of the second strapping strand thicknesses are transmitted to a control device by the sensor device and the film strand thickness is adjusted through automated control of the forming device by means of the control device.

Also this measure allows for a highly automated execution of the method.

In another, preferred embodiment of the method, it may be provided that also a second plastic material consisting of 90 wt % to 100 wt % semi-crystalline, thermoplastic, second polymer and 0 wt % to 10 wt % of another component or multiple other components is provisioned, which second plastic material is melted by means of another extrusion device while forming a second plastic melt, which second plastic melt is joined with a top side and/or a bottom side of the first plastic melt before the forming of the film strand, so that the second plastic melt covers completely the top side and/or the bottom side of the first plastic melt, and that the film strand is formed by means of the forming device by joint forming of the first plastic material and of the second plastic material, so that a multi-layer film strand is formed with a base strand layer from the first plastic material and at least one surface strand layer from the second plastic material, which surface strand layer is connected to a top side or bottom side of this base strand layer, wherein this multi-layer film strand is formed such that it consists of 50 wt % to 95 wt % of the first plastic material and 5 wt % to 50 wt % of the second plastic material.

This execution of the method enables also multi-layer plastic strappings to be produced, wherein the properties of the first plastic material in the base strand layer and the properties of the second plastic material in the surface strand layer may synergistically complement each other. In particular, the multi-layer film strand may be formed such that it consists of 55 wt % to 90 wt % of the first plastic material and 10 wt % to 45 wt % of the second plastic material. The splitting, in accordance with the method, before the step of the drawing is specifically advantageous here when forming multi-layer film and/or strapping strands, as, in contrast to a splitting after the drawing, delamination tendencies can be impeded. As turned out, in case of the forming of a multi-layer film strand and/or multi-layer first and second strapping strands, also low-quality, first plastic material can be used and/or provisioned as the first plastic material for the base strand layer. In particular, the at least one surface layer from the second plastic material, which surface layer is connected to the base strand layer, seems to provide sufficient stability to the first strapping strands after the splitting, in particular as part of the mechanically extremely straining and thus process-critical step of the drawing.

When forming a multi-layer film strand, it may be provided, for example, that the first plastic material is provisioned with a content of 50 wt % to 100 wt % of exclusively mechanically recycled plastic material. Such an execution of the method enables a more sustainable and less expensive production of the plastic strappings.

In addition to the exclusively mechanically recycled plastic material, the first plastic material may also comprise up to 50 wt % non-recycled or chemically recycled plastic material. Preferably, the first plastic material may be provisioned with a content of 80 wt % to 100 wt % of exclusively mechanically recycled plastic material and additionally up to 20 wt % non-recycled or chemically recycled plastic material. Independent of the type of production and/or preparation and/or the type of provisioning of the components for the first plastic material and as specified in the claims, the first plastic material consists of 70 wt % to 100 wt % of the thermoplastic, first polymer and 0 wt % to 30 wt % of the other component or the multiple other components.

If also the second plastic material is used and/or provisioned and utilized, a plastic material consisting of 70 wt % to 98 wt % thermoplastic, first polymer and 2 wt % to 30 wt % of another component or multiple other components may absolutely be provisioned as the first plastic material. For example, a plastic material with a content of foreign polymer, i.e. a different polymer than the first, thermoplastic polymer, may be provisioned as the first plastic material. For example, a content of foreign polymer may be from 2 wt % to 30 wt %. Here, the foreign polymer may also comprise a layer-forming gas- or liquid-barrier plastic, and/or a copolymer. Yet, also a plastic material with a content of inorganic fillers, for example a content of inorganic fillers from 2 wt % to 30 wt %, in particular 5 wt % to 30 wt %, may be provisioned as the first plastic material. The inorganic filler may be formed by chalk, talc or a mixture thereof, for example. Independent thereof or in addition, a plastic material comprising solid particles with a particle size of up to 500 μm, in particular 150 μm to 500 μm, may be provisioned as the first plastic material. Accordingly, the first plastic material may be filtered and/or may have been filtered by a filtering device with a mesh size of 500 μm as part of the melting, or as part of a melting operation performed upstream of the present method. Also a plastic material comprising colorants, such as printing inks, for example in a content of 2 wt % to 30 wt %, may be provisioned as the first plastic material. Preferably, a post-consumer-recycling (PCR) plastic material may be provisioned as the first plastic material. Also a plastic material comprising components that are non-melting at a melting and/or processing temperature as part of the melting of the first plastic material may be provisioned as the first plastic material.

The thermoplastic, first polymer may be formed by polyethylene terephthalate, polypropylene, polyethylene, polyamide or polystyrene, for example. In particular, a plastic material that consists entirely of exclusively mechanically recycled plastic material may be provisioned as the first plastic material. A non-recycled or chemically recycled plastic material, or also a high-quality, mechanically recycled plastic material, in particular a mechanically recycled post-industrial-recycling plastic material, may be provisioned as the second plastic material. It holds true also for the second plastic material that, independent of the amount of the other component or of the other components of the second plastic material, this or these other component(s) may be formed by fillers, additives, plasticizers or also by one or more other polymer(s) than the second, semi-crystalline polymer, for example.

In contrast to the first plastic material, a plastic material that does not comprise any printing inks, layer-forming gas- or liquid-barrier plastics and additionally components that are non-melting at a melting and/or processing temperature as part of the melting of the second plastic material, such as metals, wood fillers, glass (fibers) or also polymers melting at a higher temperature than the melting and/or processing temperature, may be provisioned as the second plastic material. Furthermore, a plastic material comprising a maximum content of 10 wt %, preferably a maximum of 5 wt % of inorganic filler, such as chalk or talc, or also colorants for dyeing plastic materials, for example, such as master batch dyes, may be provisioned as the second plastic material. A plastic material comprising solid particles with a particle size of up to 150 μm may be provisioned as the second plastic material. Accordingly, the second plastic material may be filtered and/or may have been filtered by a filtering device with a mesh size of 150 μm as part of the melting, or as part of a melting operation performed upstream of the present method.

An exclusively mechanically recycled plastic material is understood to mean a plastic material already utilized and/or used at least once in which no chemical recycling, in particular no chemical reaction, was carried out in a targeted manner as part of the recycling. As known, a chemical recycling may be performed by chain splitting and/or depolymerization of polymers through to monomers and subsequent repolymerization. In particular, the first plastic material may be a post-consumer and/or post-industrial article and/or plastic material.

A chemically recycled plastic material is accordingly understood to mean a plastic material in which such very chemical reactions were induced in a targeted manner, in particular a depolymerization and subsequent repolymerization were carried out, as part of the recycling. A non-recycled plastic material is understood to mean a freshly polymerized and/or produced plastic material that has not yet been utilized, i.e. a like-new plastic material and/or new plastic material.

Furthermore, it may be provided when forming a multi-layer film strand that a plastic material with a melt mass flow rate (MFR) according to ISO 1133 of 2 g/10 min to 35 g/10 min is provisioned as the first plastic material, and that a plastic material with a melt mass flow rate (MFR) according to ISO 1133 that is equal or greater in comparison to the first plastic material is provisioned as the second plastic material. This execution of the method enables in particular a process-reliable forming of the multi-layer film strand with a homogeneous and even and/or uniform formation of the layers. In particular, irregularities in the layer formation can be impeded.

Generally, the first, thermoplastic polymer and the second, semi-crystalline, thermoplastic polymer may be respectively be formed by any polymers.

Preferably, it may be provided when forming a multi-layer film strand, however, that plastic materials of the same type are provisioned as the first plastic material and as the second plastic material. This measure enables in particular the production of a film strand with a stable and permanently even layer structure and improved mutual adhesion of the base strand layer and the surface strand layer(s). Plastic materials of the same type are understood to mean plastic materials comprising the same type of thermoplastic polymer. For example, in this embodiment variant, both the first and the second plastic material may comprise respectively a polyolefin, respectively a polyester or, for example, respectively a polyamide as thermoplastic polymers as the first and/or second polymer, for example.

In particular, it may be provided when forming a multi-layer film strand that plastic materials in which a chemical molecular formula of the thermoplastic, first polymer corresponds to a chemical molecular formula of the semi-crystalline, thermoplastic, second polymer are provisioned as the first plastic material and as the second plastic material. This execution of the method enables in particular the adhesion of the surface strand layer(s) to the base strand layer to be further improved again as part of the formation of the multi-layer film strand and also in the first and second strapping strands and/or as part of the following method steps splitting and drawing, but also subsequently when using the multi-layer plastic strappings.

It may be particularly expedient when forming a multi-layer film strand if plastic materials in which both the thermoplastic, first polymer and the semi-crystalline, thermoplastic, second polymer are formed by polypropylene are provisioned as the first plastic material and as the second plastic material. Specifically plastic materials based on polypropylene have proven particularly suitable for forming the multi-layer plastic strappings.

When forming a multi-layer film strand, it may furthermore be provided that the first plastic melt and the second plastic melt are joined such as part of the method step of the joining that the second plastic melt covers completely a top side and a bottom side of the first plastic melt. This measure ensures that the multi-layer film strand and the first and second strapping strands can be further stabilized again as part of the processing and/or working, but also the multi-layer plastic strappings can be further stabilized again when being used. This is presumably because the low-quality, exclusively mechanically recycled plastic material accounting for at least 50 wt % of the first plastic material is protected and/or stabilized both at the top side and at the bottom side by respectively one surface (strand) layer from the second plastic material.

If a multi-layer film strand is formed, a plastic material with a content of 2 wt % to 30 wt % of fillers, for example, may be provisioned as the first plastic material. This ensures that in particular the production costs of the multi-layer plastic strappings can be reduced, as the provisioning of a plastic material with a high content of filler(s) is generally lower in cost.

In particular, when forming a multi-layer film stand, a plastic material with a content of 2 wt % to 30 wt % of coloring filler(s) may be provisioned as the first plastic material. Such fillers may be contained in the first plastic material as particularly low-cost materials. Nevertheless, in particular the second strapping strands, for example, may be imprinted on a surface strand layer or on the surface strand layers after the drawing, since a surface strand layer may be effective as a cover layer in relation to a base strand layer connected to the surface strand layer and a coloring of the base layer can thus be easily covered.

For the purpose of better understanding of the invention, it will be elucidated in more detail by means of the figures below.

The figures show in a respectively very simplified schematic representation:

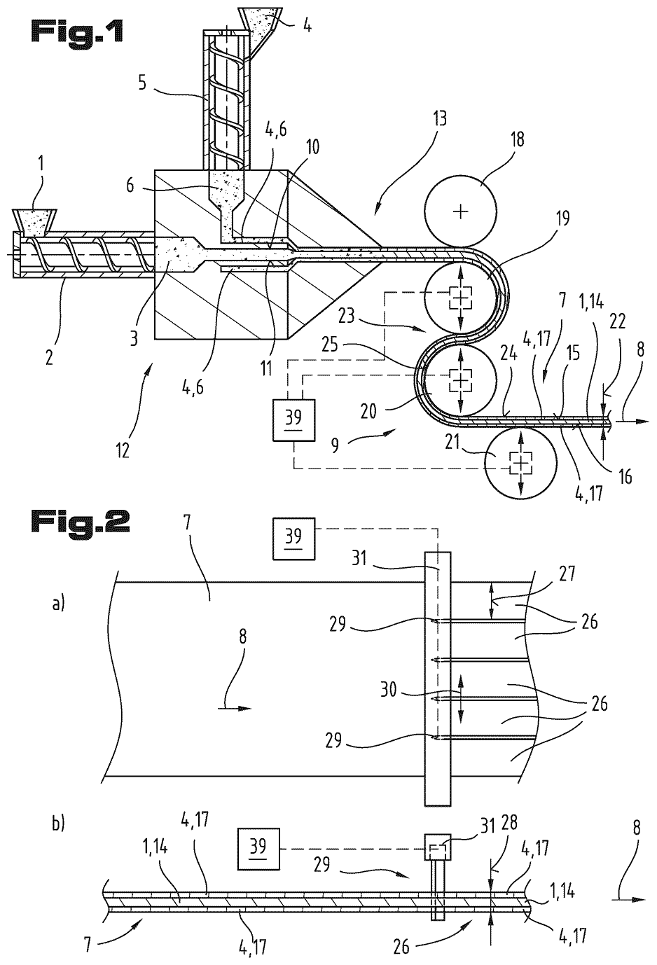

FIG. 1 an exemplary embodiment of method steps melting plastic materials, joining plastic melts and forming a film strand, in a lateral view;

FIG. 2 an exemplary embodiment of a method step splitting a film strand, in a lateral view and in a top view from above;

FIG. 3 an exemplary embodiment of a method step drawing strapping strands in a lateral view and in a top view from above;

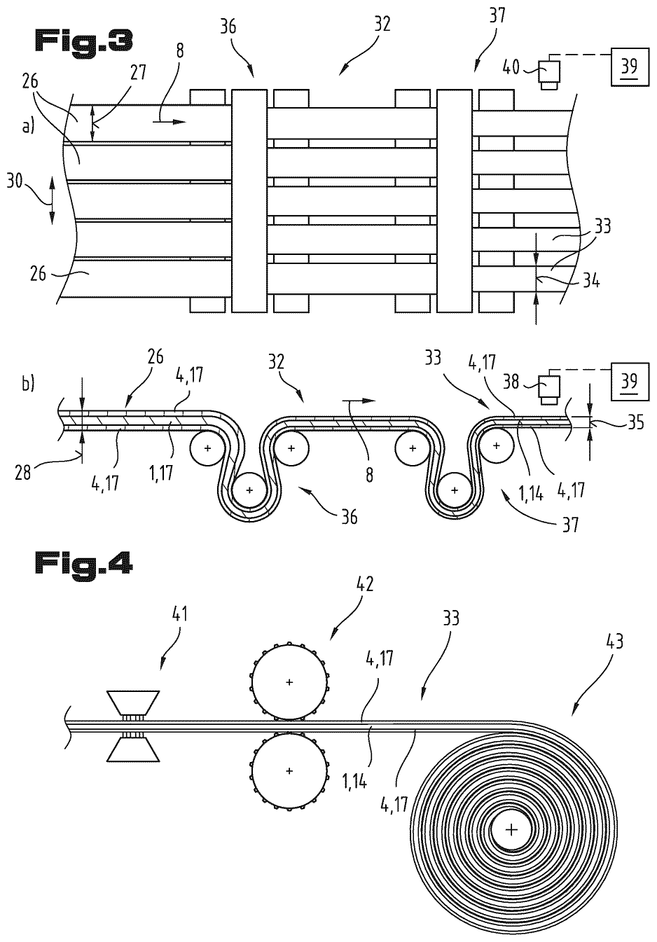

FIG. 4 an exemplary embodiment of other method steps after the drawing of strapping strands, in a lateral view.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, these specifications of location are to be analogously transferred to the new position.

The present method for producing plastic strappings may in particular be provided for producing strappings as specified in (ÖNORM) EN 13394. The method may accordingly be provided for producing plastic strappings with a tensile strength of at least 300 N/mm².

The method comprises first a provisioning of at least one first plastic material 1. Here, this at least one first plastic material 1 consists of 70 wt % to 100 wt % thermoplastic, first polymer and 0 wt % to 30 wt % of another component or multiple other components, and may in particular consist of 80 wt % to 98 wt % thermoplastic, first polymer and 2 wt % to 20 wt % of another component or multiple other components. Independent of the amount of the other component or of the other components of the first plastic material, this or these other component(s) may be formed by fillers, additives, plasticizers or also by one or more other polymer(s) than the first polymer, for example.

As schematically represented in FIG. 1, the at least one first plastic material 1 is melted by means of an extrusion device 2 while forming a first plastic melt 3. In the exemplary embodiment shown in FIG. 1, also a second plastic material 4 may be provisioned, which second plastic material 4 may be melted by means of another extrusion device 5 while forming a second plastic melt 6. For example a plastic material consisting of 90 wt % to 100 wt % semi-crystalline, thermoplastic, second polymer and 0 wt % to 10 wt % of another component or multiple other components may be provisioned as the second plastic material 4. Independent of the amount of the other component or of the other components of the second plastic material 4, this or these other component(s) may be formed by fillers, additives, plasticizers or also by one or more other polymer(s) than the semi-crystalline, second polymer, for example. However, unlike the exemplary embodiments represented in FIG. 1 and the following FIGS. 2 to 4, the method can also be carried out merely with the first plastic material 1 alone, of course. The second plastic material 4 may be processed together with the first plastic material 1 for forming a multi-layer plastic strapping, as described in more detail below. If only the first plastic material 1 is provisioned and processed, a plastic strapping with only one layer, of course, will result and/or be produced with the method.

If also a second plastic material 4 is provisioned and processed by means of the method, as described also below on the basis of the exemplary embodiments in accordance with FIGS. 1 to 4, the first plastic material 1 may be provisioned with a content of 50 wt % to 100 wt % of exclusively mechanically recycled plastic material, for example. In addition to the exclusively mechanically recycled plastic material, the first plastic material 1 may also comprise up to 50 wt % non-recycled or chemically recycled plastic material. Preferably, the first plastic material 1 may be provisioned with a content of 80 wt % to 100 wt % of exclusively mechanically recycled plastic material and additionally up to 20 wt % non-recycled or chemically recycled plastic material. The thermoplastic, first polymer may be formed by polyethylene terephthalate, polypropylene, polyethylene, polyamide or polystyrene, for example. In particular, a plastic material that consists entirely of exclusively mechanically recycled plastic material may be provisioned as the first plastic material 1.

If also the second plastic material 4 is used and/or provisioned and utilized, a plastic material consisting of 70 wt % to 98 wt % thermoplastic, first polymer and 2 wt % to 30 wt % of another component or multiple other components may absolutely be provisioned as the first plastic material 1. For example, a plastic material with a content of foreign polymer, i.e. a different polymer than the first, thermoplastic polymer, may be provisioned as the first plastic material 1. For example, a content of foreign polymer may be from 2 wt % to 30 wt %. Here, the foreign polymer may also comprise a layer-forming gas- or liquid-barrier plastic, and/or a copolymer. Yet, also a plastic material with a content of inorganic fillers, for example a content of inorganic fillers from 2 wt % to 30 wt %, in particular 5 wt % to 30 wt %, may be provisioned as the first plastic material 1. The inorganic filler may be formed by chalk, talc or a mixture thereof, for example. Independent thereof or in addition, a plastic material comprising solid particles with a particle size of up to 500 μm, in particular 150 μm to 500 μm, may be provisioned as the first plastic material 1. Accordingly, the first plastic material 1 may be filtered and/or may have been filtered by a filtering device with a mesh size of 500 μm as part of the melting, or as part of a melting operation performed upstream of the present method. Also a plastic material comprising colorants, such as printing inks, in a content of 2 wt % to 30 wt %, for example, may be provisioned as the first plastic material 1. Preferably, a post-consumer-recycling (PCR) plastic material may be provisioned as the first plastic material 1. Also a plastic material comprising components that are non-melting at a melting and/or processing temperature as part of the melting of the first plastic material may be provisioned as the first plastic material 1.

A non-recycled or chemically recycled plastic material, or also a high-quality, mechanically recycled plastic material, in particular a mechanically recycled post-industrial-recycling plastic material, may be provisioned as the second plastic material 4.

In contrast to the first plastic material 1, a plastic material that does not comprise any printing inks, layer-forming gas- or liquid-barrier plastics and additionally components that are non-melting at a melting and/or processing temperature as part of the melting of the second plastic material 4, such as metals, wood fillers, glass (fibers) or also polymers melting at a higher temperature than the melting and/or processing temperature, may be provisioned as the second plastic material 4. Furthermore, a plastic material comprising a maximum content of 10 wt %, preferably a maximum of 5 wt % of inorganic filler, such as chalk or talc, or also colorants for dyeing plastic materials, for example, such as master batch dyes, may be provisioned as the second plastic material 4. A plastic material comprising solid particles with a particle size of up to 150 μm may be provisioned as the second plastic material 4. Accordingly, the second plastic material 4 may be filtered and/or may have been filtered by a filtering device with a mesh size of 150 μm as part of the melting, or as part of a melting operation performed upstream of the present method.

If a second plastic material 4 is used, a plastic material with a melt mass flow rate (MFR) according to ISO 1133 of 2 g/10 min to 35 g/10 min may be provisioned as the first plastic material 1, and a plastic material with a melt mass flow rate (MFR) according to ISO 1133 that is equal or greater in comparison to the first plastic material may be provisioned as the second plastic material 4.

Preferably, it may be provided when processing a second plastic material 4 that plastic materials of the same type are provisioned as the first plastic material 1 and as the second plastic material 4. In particular, if an additional processing of the second plastic material 4 is provided, plastic materials in which a chemical molecular formula of the thermoplastic, first polymer corresponds to a chemical molecular formula of the semi-crystalline, thermoplastic, second polymer may be provisioned as the first plastic material 1 and as the second plastic material 4. In particular, plastic materials in which both the thermoplastic, first polymer and the semi-crystalline, thermoplastic, second polymer are formed by polypropylene may then be provisioned as the first plastic material 1 and as the second plastic material 4.

In case of the additional processing of the second plastic material 4, a plastic material with a content of 2 wt % to 30 wt % of fillers, for example, may be provisioned as the first plastic material 1. In this case, also a plastic material with a content of 2 wt % to 30 wt % of coloring filler(s) may be provisioned as the first plastic material 1.

Independent of whether merely the first plastic material 1 or additionally also the second plastic material 4 by is processed means of the method, there is a subsequent forming of a film strand 7, as can be seen from FIG. 1. This is done by feeding at least the first plastic melt 3 to a forming device 9 in a material transport direction 8. If only the first plastic material 1 is processed, this first plastic material 1 is formed into the film strand 7 by means of the forming device 9. In accordance with the exemplary embodiment represented in FIG. 1, the forming device 9 may, however, also be fed the second plastic material 4, shown here, together with the first plastic material 1, so that the film strand 7 is formed from both plastic materials 1, 4.

In this case, the procedure may be such that, before the forming of the film strand 7, the second plastic melt 6 is joined, with a top side 10 and/or a bottom side 11, with the first plastic melt 3, so that the second plastic melt 6 covers completely the top side 10 and/or the bottom side 11 of the first plastic melt 3. In particular, it may also be provided that the first plastic melt 3 and the second plastic melt 6 are joined such as part of the method step of the joining that the second plastic melt 6 covers completely the top side 10 and the bottom side 11 of the first plastic melt 3, as represented in the exemplary embodiment in accordance with FIG. 1.

If the first plastic material 1 and the second plastic material 4 are to be formed into a multi-layer film strand 7, a joining of the first plastic melt 3 and of the second plastic melt 6 may be carried out by means of multiple methods that are generally known. For example, the two plastic melts 3, 6 may be joined by means of a so-called coextrusion box 12, also referred to as a feedblock, and, after the joining, dispensed via a film extrusion tool 13 with a wide slot die and fed to the forming device 9, as illustrated roughly schematically in FIG. 1. Alternatively to the exemplary embodiment outlined in FIG. 1, also different, generally known methods for joining the plastic melts 3, 6 are conceivable, of course, such as by means of a so-called coextrusion tool and/or multi-layer dies, the use of multiple extrusion tools with respectively one die, and so on.

Subsequently, in accordance with the exemplary embodiment represented in FIG. 1, the film strand 7 may be formed by means of the forming device 9 through joint forming of the first plastic material 1 and of the second plastic material 4.

As shown in FIG. 1, this enables a multi-layer film strand 7 to be formed with a base strand layer 14 from the first plastic material 1 and at least one surface strand layer 17 from the second plastic material 4, which surface strand layer 17 is connected to a top side 15 or bottom side 16 of this base strand layer 14. In the exemplary embodiment represented in FIG. 1, it may be provided, as shown, that a triple-layer film strand 7 is formed with a base strand layer 14 from the first plastic material 1 and surface strand layers 17 from the second plastic material 4, which surface strand layers 17 are connected to a top side 15 and bottom side 16 of this base strand layer 14. Such a multi-layer film strand 7 may be formed such that it consists of 50 wt % to 95 wt % of the first plastic material 1 and 5 wt % to 50 wt % of the second plastic material 4, in particular of 55 wt % to 90 wt % of the first plastic material 1 and 10 wt % to 45 wt % of the second plastic material 4, for example.

As further illustrated in FIG. 1, the forming of the film strand 7 may be carried out by means of the forming device 9, which comprises rotatably mounted rolls 18, 19, 20, 21. As generally known, the forming device 9 may therefore be formed by a rolling mill, also referred to as a calender and/or smoothing calender, as also shown in the exemplary embodiment represented in FIG. 1. Here, a film strand thickness 22 of the film strand 7 may be adjusted in a targeted manner, for example by guiding the first plastic melt 3 and optionally also the second plastic melt 6 through a gap 23 between adjacent rolls 19, 20, as generally known and shown in the exemplary embodiment. To this end, at least one of the adjacent rolls 19, 20 may be adjustable for modifying the film strand thickness 22. A thickness of the film strand 7 after the forming and/or the film strand thickness 22 illustrated in FIG. 1 may be adjusted to 0.6 mm to 3.8 mm, preferably 0.8 mm to 2.8 mm, for example.

Furthermore, there is also a cooling down of at least the first plastic material 1, in the exemplary embodiment represented in FIG. 1 also a cooling down of the second plastic material 4, for the subsequent method step of the splitting of the film strand 7 represented in FIG. 2. The cooling down of the film strand 7 to a desired target temperature for the subsequent splitting step may be performed exclusively by means of the forming device 9 itself. To this end, the first plastic melt 3 and optionally also the second plastic melt 6 may be cooled down, for example by means of at least one temperature-controllable roll 18, 21 and/or roll with a temperature-controllable roll surface of the forming device 9. For example, a cooling agent may be able to be applied to at least one roll 18, 21 of the forming device. Additionally and/or alternatively, however, also a separate cooling down of the plastic melt(s) 3, 6 may be performed before the forming of the film strand 7 and/or an additional, separate cooling down of the film strand 7 may be performed after forming the film strand 7 by means of an additional cool-down device, such as a water bath, not represented in FIG. 1. Preferably, the film strand 7 may be cooled down to a temperature of 75° C. to 135° C., in particular 80° C. to 130° C., for the subsequent method step of the splitting.

Furthermore, at least one surface 24 of the film strand 7 may be structured by means of at least one structured roll surface 25 as part of the method step of the forming of the film strand 7. For example, the at least one surface 24 of the film strand 7 may be provided with a microstructure, in particular with a microstructure in the sense of a matting, which microstructure is not detectable by the naked eye. Alternatively, it may also be of advantage for specific applications, however, if the surfaces 24 of the film strand 7 are designed so as to be very smooth, i.e. are even smoothed by means of at least one roll surface.

In FIG. 2, the subsequent method step of the splitting of the film strand 7 is illustrated, wherein the same reference numbers are used in FIG. 2 for the same parts/elements as in the preceding FIG. 1. To avoid unnecessary repetitions, the detailed description in the preceding FIG. 1 should be noted and/or is referred to.

As can be seen from FIG. 2, a splitting and/or cutting of the film strand 7, along the material transport direction 8, into first strapping strands 26 with first strapping strand widths 27 and first strapping strand thicknesses 28 is performed by means of splitting devices 29. The splitting of the film strand may 7 be carried out by means of splitting devices 29 configured as knife blades, circular blades that are non-rotatable or rotatable along or opposite the material transport direction, or also by means of splitting devices configured as a laser or water beam, for example. Of course, the number of splitting devices 29 and/or strapping strands 26 is merely exemplary in the exemplary embodiment in accordance with FIG. 2, and the respective number of splitting devices 29 and/or strapping strands 26 may be varied, of course. In addition to the splitting devices 29 represented in FIG. 2, other splitting and/or cutting devices may be provided also in the peripheries of the film strand 7 and/or of the outer strapping strands 26 if required or desired in order to trim the edges of the outer strapping strands 26 and/or design the edges of the outer strapping strands 26 as evenly as possible.

It may further be provided in the method that at least some of the splitting devices 29 are adjusted along a direction 30 extending parallel to the strapping strand widths 27 for adjusting the first strapping strand widths 27, as illustrated in FIG. 2 by the corresponding double arrows. This measure enables in particular the first strapping strand widths 27 to be varied and/or adjusted as required and/or desired. To this end, the splitting devices 29 may be adjustably mounted and/or held at holding bars 31 aligned parallel to the direction 30 of the strapping strand widths 27, for example, as schematically represented in FIG. 2. In particular, all existing splitting devices 29 may be adjusted along the direction 30 extending parallel to the strapping strand widths 27 for adjusting the first strapping strand widths 27. In addition, in the context of the adjusting along the direction 30 of the strapping strand widths 27, it may also be provided, however, that at least some of the splitting devices 29 are adjusted away from the film strand 7 and/or the first strapping strands 26.

Subsequently to the method step of the splitting and as illustrated in FIG. 3, a drawing to second strapping strands 33 with second strapping strand widths 34 and second strapping strand thicknesses 35 in the material transport direction 8 of the first strapping strands 26 is carried out by means of a stretching device 32. Also in FIG. 3, the same reference numbers and/or component designations as in the preceding FIGS. 1 and 2 are used for the same parts again. To avoid unnecessary repetitions, the detailed description in the preceding FIGS. 1 and 2 should be noted and/or is referred to.

As generally known, the drawing and/or stretching device 32 may be formed by a so-called stretching unit, in which the first strapping strands 26 are elongated and/or drawn to the second strapping strands 33 in a transport direction 8 by means of successively faster rotating stretching and/or stripping devices 36, 37. This achieves the desired preferred orientation of the macromolecule chains of the plastic material 1, or, in case of multi-layer strapping strands 26, 33, of the plastic materials 1, 4. Depending on the plastic material(s) 1, 4 used, the strapping strands 26, 33 can be drawn with drawing ratios of 1:4 to 1:20. Upstream of the stretching device 32, or optionally between stripping devices 36, 37 of the stretching device 32 and/or the stretching unit, also at least one temperature-control device may be arranged in addition in order to allow for a targeted control of the temperature of the plastic material 1 or of the plastic materials 1, 4 for the drawing operation, as generally known. Such temperature-control devices, such as water baths, cooling or heating air, or infrared radiators, are generally known from the prior art and are not represented in more detail in FIG. 3.

The drawing and/or the elongation of the first strapping strands 26 to the second strapping strands 33 is accompanied by a deforming, of course, in particular by a reduction of the cross section, so that the second strapping strand widths 34 and thicknesses 35 are smaller than the first strapping strand widths 27 and thicknesses 28, as can also be seen from FIG. 3. The drawing enables the second strapping strand thicknesses 35 to be adjusted to a value of 0.15 mm to 1.8 mm, preferably of 0.2 mm to 1.4 mm, for example. Through the splitting and subsequent drawing, the second strapping strand widths 34 can be adjusted to a value of 3 mm to 40 mm, in particular 4 mm to 36 mm, wherein the second strapping strand widths 34 may be selected predominantly according to the respectively intended purpose of use for the plastic strappings.

As can best be seen in a combination of FIG. 2 and FIG. 3, it may be provided in the method that, subsequently to the drawing, actual values of the second strapping strand widths 34 are detected by means of at least one sensor device 38 and the splitting devices 29 are adjusted along the direction 30 extending parallel to the strapping strand widths 34 with respect to respectively desired target values for the second strapping strand widths 34 for adjusting the first strapping strand widths 27 on the basis of these detected actual values. Here, the sensor device 38 may be formed by an optical sensor device, in particular by a camera.

As can also best be seen in a combination of FIG. 2 and FIG. 3, it may furthermore be provided that the detected actual values of the second strapping strand widths 34 are transmitted to a control device 39 by the sensor device 38 and the splitting devices 29 are adjusted along the direction 30 extending parallel to the strapping strand widths 27, 34 through automated control by the control device 39 for adjusting the first strapping strand widths 27. A connection, in terms of signal technology, between the sensor device 38, FIG. 3, and the splitting devices 29, FIG. 2, to the control device 39 is indicated in FIGS. 2 and 3 respectively by the dashed lines.

As can best be seen in a combination of FIG. 1 with FIG. 3, actual values of the second strapping strand thicknesses 35 may be detected by means of at least one sensor device 40 in the method subsequently to the drawing, and a and/or the film strand thickness 22 of the film strand 7, and therefore also the first strapping strand widths 27 of the first strapping strands 26 before the drawing, may be adjusted with respect to respectively desired target values for the second strapping strand thicknesses 35 by means of the forming device 9. Also the at least one sensor device 40 for determining the actual values of the second strapping strand thicknesses 35 may be formed by an optical sensor, in particular a camera, again. Here, basically the same sensor device 38 that is also used to determine the second strapping strand widths 34 can be used, or also a separate sensor device 40, of course, as illustrated in FIG. 3.

Also in the context of the detecting of the actual values of the second strapping strand thicknesses 35, it may be provided that these detected actual values of the second strapping strand thicknesses 35 are transmitted to a and/or the control device 39 by the sensor device 40 and the film strand thickness 22 is adjusted through automated control of the forming device 9 by means of the control device 39. Also the connections, in terms of signal technology, of the sensor device 40 and the forming device 9 to the control device 39 required to this end are indicated by dashed lines in FIG. 1 and FIG. 3.

FIG. 4 shows even more possible steps of the method following the drawing. Also in FIG. 4, the same reference numbers and/or component designations as in the preceding FIGS. 1 to 3 are used for the same parts again. To avoid unnecessary repetitions, the detailed description in the preceding FIGS. 1 to 3 should be noted and/or is referred to.

For example, it may be provided that the second strapping strands 33 and/or a or both of their surfaces are subjected to a surface treatment by means of one or multiple surface treatment device(s) 41. A corresponding surface treatment may comprise, for example, a coating of the surface(s), such as with a wax or another coating agent. Yet, a surface treatment may also comprise a radiation or plasma treatment of the surface(s) of the second strapping strands 33, for example.

Furthermore, a surface or both surfaces of the second strapping strands 33 may be embossed by means of an embossing device 42, for example. This may optionally be performed additionally to the structuring by means of the forming device 9 mentioned above.

Finally, the second strapping strands 33 may be custom packaged, as also illustrated in FIG. 4, for example wound up on the wind-up device 43 shown in FIG. 4, often also referred to as a winding machine, and thus prepared for a transport.

It should finally be mentioned for the sake of completeness that, contrary to the embodiment shown here with a multi-layer, in particular triple-layer film strand 7, first strapping strands 26 and second strapping strands 33, the method represented in FIGS. 1 to 4 may of course also be carried out with a merely single-layer film strand 7, i.e. accordingly also single-layer first and second strapping strands 26, 33 that respectively consist only of the first plastic material 1.

The exemplary embodiments show possible embodiment variants, wherein it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

Any and all specifications of value ranges in the description at issue are to be understood to comprise any and all sub-ranges of same, for example the specification 1 to 10 is to be understood to mean that any and all sub-ranges starting from the lower limit 1 and from the upper limit 10 are comprised therein, i.e. any and all sub-ranges start at a lower limit of 1 or larger and end at an upper limit of 10 or less, e.g. 1 to 1.7, or 3.2 to 8.1, or 5.5 to 10.

Finally, as a matter of form, it should be noted that for ease of understanding of the structure, elements are partially not depicted to scale and/or are enlarged and/or are reduced in size.

### TABLE OF REFERENCE NUMBERS

1 plastic material 32 stretching device
2 extrusion device 33 strapping strand
3 plastic melt 34 strapping strand width
4 plastic material 35 strapping strand thickness
5 extrusion device 36 stripping device
6 plastic melt 37 stripping device
7 film strand 38 sensor device
8 material transport direction 39 control device
9 forming device 40 sensor device
10 top side 41 surface treatment device
11 bottom side 42 embossing device
12 coextrusion box 43 wind-up device
13 film extrusion tool
14 base strand layer
15 top side
16 bottom side
17 surface strand layer
18 roll
19 roll
20 roll
21 roll
22 film strand thickness
23 gap
24 surface
25 roll surface
26 strapping strand
27 strapping strand width
28 strapping strand thickness
29 splitting device
30 direction
31 holding bars

1. A method for producing plastic strappings, comprising the following method steps,
providing at least one first plastic material (1) comprising 70 wt % to 100 wt % thermoplastic, first polymer and 0 wt % to 30 wt % of another component or multiple other components,
subsequently melting the first plastic material (1) using an extrusion device (2) while forming a first plastic melt (3),
subsequently forming a film strand (7) by feeding at least the first plastic melt (3) to a forming device (9) in a material transport direction (8), and cooling down the first plastic material (1),
subsequently splitting the film strand (7) into first strapping strands (26) with first strapping strand widths (27) and first strapping strand thicknesses (28) along the material transport direction (8) using splitting devices (29),
subsequently drawing the first strapping strands (26) into second strapping strands (33) with second strapping strand widths (34) and second strapping strand thicknesses (35) in the material transport direction (8) using a stretching device (32).

2. The method according to claim 1, wherein the film strand (7) is cooled down to a temperature of 75° C. to 135° C. for the method step of the splitting.

3. The method according to claim 1, wherein the forming of the film strand (7) is carried out using the forming device (9), which comprises rotatably mounted rolls (18, 19, 20, 21).

4. The method according to claim 3, wherein at least one surface (24) of the film strand (7) is structured using at least one structured roll surface (25) as part of the method step of the forming of the film strand (7).

5. The method according to claim 1, wherein at least some of the splitting devices (29) are adjusted along a direction (30) extending parallel to the strapping strand widths (27, 34) for adjusting the first strapping strand widths (27).

6. The method according to claim 5, wherein, subsequently to the drawing, actual values of the second strapping strand widths (34) are detected using at least one sensor device (38) and the splitting devices (29) are adjusted along the direction (30) extending parallel to the strapping strand widths (27, 34) with respect to respectively desired target values for the second strapping strand widths (34) for adjusting the first strapping strand widths (27) on the basis of these detected actual values.

7. The method according to claim 6, wherein the detected actual values of the second strapping strand widths (34) are transmitted to a control device (39) by the sensor device (38) and the splitting devices (29) are adjusted along the direction (30) extending parallel to the strapping strand widths (27, 34) through automated control by the control device (39) for adjusting the first strapping strand widths (27).

8. The method according to claim 1, wherein, subsequently to the drawing, actual values of the second strapping strand thicknesses (35) are detected using at least one sensor device (40) and wherein a film strand thickness (22) of the film strand (7) is adjusted with respect to respectively desired target values for the second strapping strand thicknesses (35) using the forming device (9).

9. The method according to claim 8, wherein the detected actual values of the second strapping strand thicknesses (35) are transmitted to a control device (39) by the sensor device (40) and the film strand thickness (22) is adjusted through automated control of the forming device (9) using the control device (39).

10. The method according to claim 1, wherein also a second plastic material (4) comprising 90 wt % to 100 wt % semi-crystalline, thermoplastic, second polymer and 0 wt % to 10 wt % of another component or multiple other components is provided, wherein the second plastic material (4) is melted using another extrusion device (5) while forming a second plastic melt (6), wherein the second plastic melt (6) is joined with a top side (10) and/or a bottom side (11) of the first plastic melt (3) before the forming of the film strand (7), so that the second plastic melt (6) covers completely the top side (10) and/or the bottom side (11) of the first plastic melt (3), and wherein the film strand (7) is formed using the forming device (9) by joint forming of the first plastic material (1) and of the second plastic material (4), so that a multi-layer film strand (7) is formed with a base strand layer (14) from the first plastic material (1) and at least one surface strand layer (17) from the second plastic material (4), wherein the at least one surface strand layer (17) is connected to a top side (15) or bottom side (16) of this base strand layer (14), wherein this multi-layer film strand (7) is formed such that the multi-layer film strand (7) comprises 50 wt % to 95 wt % of the first plastic material (1) and 5 wt % to 50 wt % of the second plastic material (4).
